(19) United States
(12) Patent Application Publication
(10) Pub. No.: US 2006/0063660 A1
(43) Pub. Date: Mar. 23, 2006

(54) Bismuth oxide glass and process of making thereof

(76) Inventors: Bianca Schreder, Frankfurt (DE); Martin Letz, Klein-Winternheim (DE); Ulrich Peuchert, Bodenheim (DE); Joseph S. Hayden, Clarks Summit, PA (US); Sally Pucilowski, Luzerne, PA (US)

Correspondence Address: HARNESS, DICKEY & PIERCE, P.L.C., P.O. BOX 828, BLOOMFIELD HILLS, MI, 48303, US

(21) Appl. No.: 11/205,913

(22) Filed: Aug. 17, 2005

Related U.S. Application Data
(63) Continuation of application No. PCT/EP04/00530, filed on Jan. 23, 2004.

(30) Foreign Application Priority Data
Feb. 20, 2003 (DE) 103 08 476.2-45

(51) Int. Cl. C03C 3/253

(52) U.S. Cl. 501/42

(57) ABSTRACT

An optically active glass containing bismuth oxide and germanium oxide is disclosed which comprises 0.1 up to less than 5 mol-% of B₂O₃ and SiO₂ in total. In addition the glass comprises 10 to 60 mol-% of Bi₂O₃ and 10 to 60 mol-% of GeO₂. The glass may further comprise 0-15 wt-% of rare earths, 0-30 wt-% of M′₂O, 0-20 wt-% of M″O, 0-15 wt-% of La₂O₃, 0-40 wt-% of Ga₂O₃, 0-10 wt-% of Gd₂O₃, 0-20 wt-% of Al₂O₃, 0-10 wt-% of CeO₂, 0-30 wt-% of ZnO, wherein M′ is at least one component selected from the group formed by Li, Na, K, Rb and Cs, and wherein M″ is at least one component selected from the group formed by of Be, Mg, Ca, Sr and Ba. Also a suitable method of preparation is disclosed.

### RELATED APPLICATIONS

This application is a continuation application of copending International Patent Application PCT/EP2004/000530 filed on Jan. 23, 2004 claiming priority of German patent application 10308476.2 filed on Feb. 20, 2003 and being fully incorporated by reference herewith.

### BACKGROUND OF THE INVENTION

The present invention relates to a bismuth oxide glass comprising germanium oxide, a process of making such a glass and a use of such a glass, as well as to a glass fiber comprising the glass according to the invention.

Optical amplifier devices are regarded as one of the key components of modern optical information technology, in particular in the WDM technique (WDM: Wavelength Division Multiplexing). Up to now in the prior art primarily optically activated ion doped quartz glasses have been used as core glasses for optical amplifiers. Er doped amplifiers based on SiO₂ allow for a simultaneous amplification of several channels which are very close in the range of 1.5 μm and differentiated by their wavelength. However, due to the narrow bandwidth emission of the Er³⁺ in SiO₂ glasses, these are not suitable to meet the increasing demands with respect to transmission bandwidth.

Thus the demand of glasses in which rare earth ions emit with a significantly broader bandwidth than in SiO₂ glasses is increasing. In this regard glasses comprising heavy elements, such as heavy metal oxide glasses or heavy metal oxide containing glasses, respectively (“HMO glasses”), are preferred. These heavy metal oxide glasses, due to their weak interatomic bondings have large interatomic electrical fields and thus lead to a broader emission of the rare earth ions, due to their larger Stark-splitting from the base state to exited states. Glasses based on tellurium oxide, bismuth oxide and antimony oxide are examples for such glasses.

However, such heavy metal oxide containing glasses, in particular when compared with SiO₂ glasses, have some disadvantages which have not yet been overcome in the prior art.

Naturally, such glasses have weak interatomic bonding forces and are mechanically less stable when compared with SiO₂ fibers. However, a good mechanical stability in particular for the manufacture of broadband fiber amplifiers is particularly relevant with respect to a durable reliability. To allow mounting in suitable amplifier housings fibers drawn from these glasses must allow to be rolled onto diameters of about 5 to 10 cm without breaking. Also the glass fibers should remain permanently stable when being in the rolled state.

In addition, heavy metal oxide containing glasses have a considerably lower melting point and softening point than SiO₂. Therefore, connecting a SiO₂ fiber with a heavy metal oxide containing fiber, e.g. by thermal arc welding (so-called splicing) is difficult. It is thus desired to obtain a difference between the softening point of the heavy metal oxide glass and the SiO₂ glass as small as possible.

Also some heavy metal oxide containing glasses show a pronounced tendency for crystallization which, of course, is disadvantageous for using such glasses in the manufacture of optical amplifiers and the like.

A heavy metal oxide containing glass being doped with rare earth ions for application as an optically active glass, and a glass product, respectively, such as a fiber or a waveguide substrate, for an application as a broadband amplifier medium in telecommunication shall fulfill depending on the respective application several, if possible, of the following key requirements:
broad and shallow absorption and emission bands of the rare earth ions not only in the range of the C transmission band around 1550 nm, but particularly in this range,
sufficient lifetime of the emitting state or of the laser levels, respectively,
thermal durability as high as possible, i.e. a high softening point,
crystallization tendency as small as possible,
high mechanical stability,
good meltability when using common melting processes, and
good fiber drawing ability.

From WO 01/55041 A1 a bismuth oxide containing glass is already known having a matrix glass with 20 to 80 mol-% Bi₂O₃, 5 to 75 mol-% B₂O₃+SiO₂, 0.1 to 35 mol-% Ga₂O₃+WO₃+TeO₂, up to 10 mol-% Al₂O₃, up to 30 mol-% GeO₂, up to 30 mol-% TiO₂ and up to 30 mol-% SnO₂, wherein the glass does not contain any CeO₂, and wherein 0.1 to 10 wt.-% erbium is integrated in the glass matrix. However, the preferred addition of tungsten oxide and tellurium oxide is disadvantageous. The addition of tellurium oxide increases the potential for reducing Bi³⁺ to elemental Bi⁰ and thus the danger of a black coloring of the glass. The addition of tungsten oxide to heavy metal oxide containing glasses leads to an increased instability of the glasses with respect to crystallization and may lead to the precipitation of elemental W⁰. By contrast, the addition of TiO₂ may lead to a considerably increased crystallization tendency.

From WO 00/23392 A1 an optically active glass comprising a glass matrix is known which is doped with 0.01 to 10 wt.-% of erbium, wherein the glass matrix comprises 20 to 80 mol-% Bi₂O₃, 0 to 74.8 mol-% B₂O₃, 0 to 79.99 mol-% SiO₂, 0.01 to 10 mol-% CeO₂, 0 to 50 mol-% Li₂O, 0 to 50 mol-% TiO₂, 0 to 50 mol-% ZrO₂, 0 to 50 mol-% SnO₂, 0 to 30 mol-% WO₃, 0 to 30 mol-% TeO₂, 0 to 30 mol-% Ga₂O₃, 0 to 10 mol-% Al₂O₃.

Also in this regard the addition of tungsten oxide is considered to be disadvantageous. Also the addition of TiO₂ and ZrO₂ leads to an increased crystallization tendency.

In addition, from EP 1 180 835 A2 an optical amplifier glass is known having a matrix glass which is doped with 0.001 to 10 wt.-% Tm (thulium). Herein the matrix glass comprises 15 to 80 mol-% Bi₂O₃ and at least SiO₂, B₂O₃ or GeO₂. If the matrix glass comprises GeO₂, then it contains solely Bi₂O₃, but no SiO₂ or B₂O₃.

Although the afore-mentioned glass may basically be advantageous with respect to optical amplifier applications, still the characteristics to be reached herewith can be improved. Also the additions of TiO₂ and ZrO₂ used in the known glasses are basically disadvantageous with respect to an increased crystallization tendency.

### SUMMARY OF THE INVENTION

It is a first object of the invention to disclose a bismuth oxide containing glass being improved with respect to the afore-mentioned demand requirements and which can avoid the disadvantages occurring in the prior art at least to some extent.

It is a second object of the invention to disclose a bismuth oxide containing glass which is particularly suitable for optical amplifier applications or laser applications.

It is a third object of the invention to disclose an optically active bismuth oxide containing glass having broad and shallow absorption and emission bands.

It is a forth object of the invention to disclose an optically active rare earth doped bismuth oxide glass having a broad and shallow absorption and emission in the C transmission band around 1550 nm.

It is a fifth object of the invention to disclose an optically active rare earth doped bismuth oxide glass having a sufficient lifetime of the emitting state or of the laser levels, respectively.

It is a sixth object of the invention to disclose an optically active rare earth doped bismuth oxide glass having a high thermal durability as, in particular a high softening point.

It is a seventh object of the invention to disclose an optically active rare earth doped bismuth oxide glass having a small crystallization tendency.

It is a further object of the invention to disclose an optically active rare earth doped bismuth oxide glass having a high mechanical stability.

It is a still further object of the invention to disclose an optically active rare earth doped bismuth oxide glass having a good meltability when using common melting processes.

It is still a further object of the invention to disclose an optically active rare earth doped bismuth oxide glass having a good fiber drawing ability.

Also a suitable process of making such a glass shall be disclosed.

These and other objects of the invention are achieved by a bismuth oxide glass comprising the following components (in mol-%, based on oxide):

| | |
|---|---|
| Bi₂O₃ | 10-18 |
| GeO₂ | ≧1 |
| B₂O₃ + SiO₂ | ≧0.1, but <5 |
| other oxides | 18.9 to 88.9 |

Surprisingly, it has been found that the bismuth oxide containing and germanium oxide containing glasses show a particularly good glass quality and good optical characteristics, in particular when the total content of B₂O₃ and SiO₂ is smaller than 5 mol-% but at the same time larger than 0.1 mol-%. Herein the transformation temperature T_{g} is sufficiently high, and the crystallization temperature Tₓ shows a sufficient gap from the transformation temperature. This is advantageous, when the glass shall be further processed after a first cooling and growing cold from the glass melt. The further the crystallization temperature Tₓ is above the transformation temperature T_{g}, the smaller is the potential that upon reheating a crystallization results which usually renders the glass unsuitable.

Also surprisingly the thermal stability of bismuth oxide containing glasses is increased in total by the addition of germanium oxide. Herein an increased or improved thermal stability of a glass is understood as to require a higher temperature reaching a particular viscosity of the glass, then required with a glass having a smaller or worse thermal stability. For instance the transformation temperature T_{g} and/or the softening point EW of a thermally more stable glass are increased when compared to a base glass free of germanium oxide. The addition of boron oxide or silicon oxide, respectively, in the given amount not only improves the mechanical characteristics of the glass, but in particular also the spectroscopic characteristics of the glass, in particular the bandwidth of amplification and the flatness of amplification. On the other hand, a too high addition of B₂O₃ leads to a decrease in the luminescence lifetime, due to the increasing water content and also due to the influence of the phonone energies. A high luminescent lifetime is desirable to reach the necessary inversion for a broadband amplification. The boric acid content according to the invention thus in particular leads to an optimal trade-off between a broadband and homogenous amplification and a sufficiently long luminescent lifetime.

According to a preferred development of the invention the bismuth oxide glass comprises the following components (in mol-%, based on oxide):

| | |
|---|---|
| B₂O₃ | ≧1 |
| Bi₂O₃ | 10-60 |
| GeO₂ | 10-60 |
| rare earths | 0-15 |
| M′₂O | 0-30 |
| M″O | 0-20 |
| La₂O₃ | 0-15 |
| Ga₂O₃ | 0-40 |
| Gd₂O₃ | 0-10 |
| Al₂O₃ | 0-20 |
| CeO₂ | 0-10 |
| ZnO | 0-30 |
| other oxides | rest, |

wherein M′ is at least one of Li, Na, K, Rb and/or Cs, and M″ is at least one of Be, Mg, Ca, Sr and/or Ba.

As known in the art, it is necessary to add rare earths to obtain an optically active glass. In this regard it is preferred to add 0.005 to 15 mol-% (based on oxide) of a rare earth, however, preferably no thulium.

In particular the addition of 0.01 to 8 mol-% of Er₂O₃ and/or of Eu₂O₃ is preferred.

However, if the glass shall merely be used as a cladding glass for glass fibers, then also a utilization of the glass without the addition of rare earths is suitable.

With respect to the use of B₂O₃ in particular additions between about 3 and 4.95 mol-% have been shown to be advantageous with respect to an improvement of the optical characteristics.

Additions of Ga₂O₃ and La₂O₃ have been found to be advantageous to facilitate the glass forming and to counteract crystallization.

The addition of tungsten oxide is basically suitable to improve the bandwidth and homogeneity of amplification, however increases the potential of an increased crystallization tendency.

It has been found that the addition of the classical network modifiers Na₂O and Li₂O, respectively, may be suitable to improve the glass forming. Also the addition of these network modifiers in the range between about 0.5 and 15 mol-% of Na₂O and/or Li₂O in part leads to improved optical characteristics within certain limits. While the addition of Na₂O shifts the amplification to lower energies, the bandwidth usually is not influenced disadvantageously.

The addition of alkaline oxides, in particular Na₂O, is particularly advantageous when the glass is to be used for planar applications, such as planar waveguides and planar optical amplifiers when using the ion exchange technique.

By adding Li₂O the bandwidth can be improved in particular in the low energy range of the spectrum (L-band). Also when compared with additions of Na₂O a broader glass forming region is obtained.

The addition of La₂O₃ leads to an improved glass forming, in particular, when up to a maximum of 8 mol-%, particularly a maximum of 5 mol-% is added. Herein La₂O₃ may easily be exchanged with Er₂O₃ or Eu₂O₃. The maximum of amplification is shifted by the addition of La₂O₃ to higher energies, while the bandwidth is somewhat decreased.

The addition of Al₂O₃ in general does not influence the optical characteristics and may, at most, be suitable in smaller quantities, since otherwise, if more than 5 mol-% are added, the glass stability may be impaired.

Additions of ZnO and BaO (or BeO, MgO, CaO, SrO, respectively) have been found to be advantageous in improving the glass stability.

In this regard, preferably, about 1 to 15 mol-%, particularly preferred about 2 to 12 mol-%, of ZnO are added. Particularly, up to about 10 mol-% of ZnO advantageous effects with respect to the glass stability are found. With respect to adding BaO (or BeO, MgO, CaO, SrO, respectively), additions up to about 10 mol-%, in particular up to about 5 mol-%, have been found to improve the glass stability.

Also additions of up to 40 mol-% and up to 10 mol-%, respectively, of Ga₂O₃ and Gd₂O₃, respectively, have been found to be advantageous for the glass formation.

Possibly the glasses according to the invention may contain additions of halogenides such as F⁻ or Cl⁻ up to 10 mol-%, in particular up to about 5 mol-%.

In case the glass according to the invention is used as a so-called passive component, such as a cladding around an optically active core of an amplification fiber, then it preferably does not contain any optically active rare earths. However, with respect to particular embodiments it may also be preferred that basically passive components such as claddings of amplification fibers comprise low amounts of optically active rare earths. If the glasses according to the invention are doped with rare earths, then they are particularly suited as optically active glasses for optical amplifiers and lasers. Preferably, the dopant is an oxide which is selected from Pr, Nd, Pm, Sm, Eu, Gd, Tb, Dy, Ho, Er, Yb and/or Lu. Particularly preferred are oxides of the elements Er, Pr, Nd and/or Dy, wherein oxides of Er or Eu are mostly preferred. Doping of the glasses with rare earths leads to optical activity, whereby the glass according to the invention is enabled for stimulized emission, if excited by a suitable pumping source, such as a laser.

The glasses according to the invention may also comprise cerium oxide. Preferably the glasses according to the invention contain only a small addition of CeO₂, in the range of a maximum of 1 mol-%, or are free of cerium.

It has been found that the melting conditions may have a significant influence on the glass quality, in particular also on the oxidation state of bismuth. Precipitating elemental bismuth in the form of a fine black precipitation impairs the optical characteristics, in particular the transparency of the glass. Moreover, the occurrence of Bi⁰ leads to the potential of alloying with common crucible materials, in particular with platinum. This process increases crucible corrosion and leads to alloyed particles which may lead to undesired disturbances of the fiber characteristics, e.g. in a fiber drawing process. The addition of cerium oxide for stabilizing the high oxidation state of bismuth is a basic solution. However, in particular at higher cerium oxide additions, this may lead to yellowish orange coloring. Also by adding cerium oxide the UV edge of the glass is shifted into the range of the Er³* emission line at 1550 nm.

According to the invention it was found that the oxidation state of bismuth can be stabilized reliably, if the glass is molten under oxidizing conditions. For instance this may be achieved by bubbling oxygen into the glass melt. If, however, cerium oxide is used for stabilization, this effects a stabilization of the oxidation state of bismuth only at melting temperatures above 1000° C., while it has a destabilizing effect below 1000° C.

### BRIEF DESCRIPTION OF THE DRAWINGS

Further characteristics will be explained with respect to FIGS. 1 to 3. Herein show:

FIG. 1 the Er³⁺ term scheme;

FIG. 2 the absorption and emission spectra of the glasses 32, 33, 35 and 36 in the C-band (normalized intensity over wavelength in nm); and

FIG. 3 the computed amplifications of the glasses 33, 34 and 36 in the C-band (normalized amplification shown over wavelength in nm).

### DETAILED DESCRIPTION OF PREFERRED EMBODIMENTS

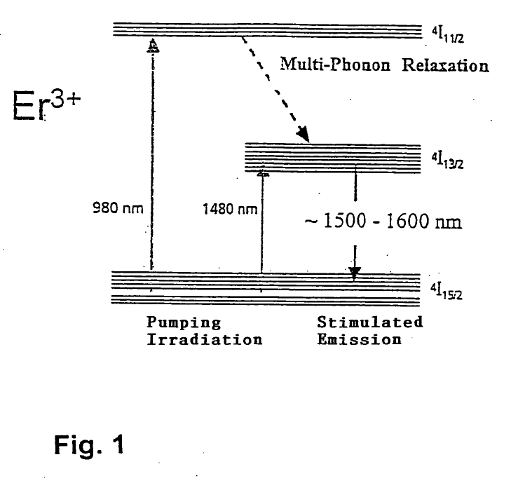

The optical activity of glasses by doping with rare earths is depicted by FIG. 1. FIG. 1 shows the energy-term scheme of Er³⁺. Excited by a pumping irradiation the upper laser level ⁴I_{13/2} is populized either indirectly (980 nm via ⁴I_{11/2}) or directly (1480 nm). By an entering signal photon excited Er³⁺-ions are brought to a stimulized emission, e.g. electrons relax to the base state ⁴I_{15/2} under emission of photons within the signal wavelength. Depending on the state of splitting of the multiplets (Stark-levels) from the upper to the lower laser level Er³⁺ emits within the 1550 nm band narrower or broader. Again the splitting depends on the local surroundings of the Er³⁺-ions within the glass matrix.

### EXAMPLES

The used glass compositions and the characteristics of the glasses are summarized in Tables 1 to 15.

Herein, partially also glasses not being subject of the invention are shown for comparative purposes.

All glass compositions of the examples were molten in platinum crucibles from pure raw materials not yet optimized with respect to trace contaminants. After about 1.5 hours the liquid glass was poured into pre-heated graphite molds and was cooled down from T_{g} to room temperature in a cooling furnace at cooling rates of 15 K/h.

In Table 1 the glass compositions of two glasses 1 and 2 according to the invention are shown in contrast to test glasses VG-1 and VG-2 which are not subject of the invention. The respective characteristics are summarized in Table 2.

While the glasses 1 and 2 had a relatively good glass stability, the two glasses VG-1 and VG-2 (without additions of SiO₂ or B₂O₃) had a worse stability and were partially crystalline.

Additions of boric acid (B₂O₃) were found to be particularly effective up to 5 mol-% in improving the glass stability. By B₂O₃ additions the amplification bandwidth as also the flatness of the amplification can be improved. Herein boron influences the position of the peak value of the magnetic transition (MT) in Bi-glasses of all kinds and, therefore, has an important influence onto the amplification bandwidth as also onto the flatness.

However, due to the water content B₂O₃ may have a certain detrimental effect on the luminescence lifetime τ.

Thus with the glasses according to the invention a balance between a sufficient boric acid addition for a broad and flat amplification and between a lower boric acid addition for a sufficient emission lifetime was found.

It was found that the germanium oxide in Er-doped bismuth oxide containing glasses has a significant influence on the position of the intensity maximum of the absorption and/or emission bands of the erbium around 1550 nm, and thereby influences the flatness of the amplification in the C-band positively.

In Table 3 the compositions of a further series of glasses according to the invention are summarized which, when compared with the glasses of Table 1 (apart from glass 3) show a further improved glass stability.

Glass 3 shows the detrimental effect of WO₃ on the glass stability. Depending on the melting conditions additions of tungsten oxide may lead to the precipitation of W⁰, whereby the glass stability may be strongly impaired. Also an increased crystallization tendency results therefrom. Thus tungsten oxide which would basically be positive for the optical characteristics (improvement of bandwidth) is more detrimental.

The respective characteristics of the glasses of Table 3 are summarized in Table 4. Herein HV depicts the Vickers hardness, B the bending strength, and K_{IC} the fracture toughness (critical tension intensity factor). The modulus of elasticity (Y-value) is derived from the Vickers hardness (should be as high as possible).

In Table 5 and Table 6 another series of glasses according to the invention, which are free of gallium oxide, are shown.

Herein the glass 10 has a Na₂O fraction of 5 mol-% which leads to an improved ion exchange characteristic of the glass. Glasses having an improved ion exchange ability are particularly suited for planar applications, such as for planar amplifiers.

However, all in all better optical characteristics were reached with bismuth oxide containing glasses which did not only contain germanium oxide, but also gallium oxide.

A series of such glasses and the characteristics thereof are summarized in Tables 7 and 8.

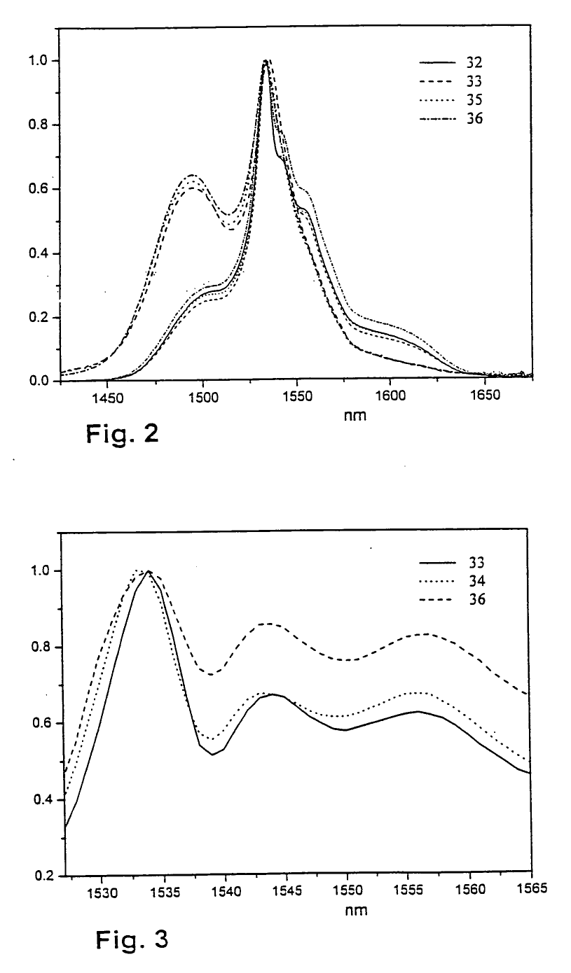

FIG. 2 shows a representation of a normalized amplification of these glasses, shown above the wavelength in nm, in the C-band region.

An increased doping with Er₂O₃ leads to an improved amplification with the glass 16.

A small addition of cerium oxide improves the bandwidth of the amplification, the flatness as well as the lifetime (see glass 16).

On the low energy side of MT the most pronounced improvement of the emission intensity is found in glass 12, which has a good amplification in the C-band. Merely the glasses with higher Er-dopings 14 and 16 have a similarly high amplification in the C-band region (C-band: 1530 to 1562 nm).

A further series of glasses according to the invention as well as their characteristics is summarized in Tables 9 and 10.

The glasses according to Tables 9 and 10 are glasses which were developed in particular for planar applications. In particular, for improving the ion conductivity, to some extent sodium oxide may be added to some extent, or lithium oxide may be replaced by sodium oxide which, however, may lead to some decrease in the glass quality by a somewhat increased crystallization tendency.

The addition of cerium oxide while simultaneously increasing the germanium oxide and bismuth oxide content to a certain extent at the cost of lithium oxide, leads to an improved glass quality as well as to better optical characteristics (glass 20).

Further glasses and their characteristics are summarized in Tables 11 and 12.

In Table 13 the glass compositions and characteristics of a series of glasses are summarized which are particularly suitable as glasses for planar broadband amplifiers on the basis of ion-exchange. All of these glasses have an excellent glass quality.

The advantageous optical glass characteristics can be seen from FIGS. 2 and 3.

It was found to be advantageous to provide the sodium oxide during melting of the glasses not in the form of sodium nitrate, but instead in the form of sodium carbonate.

Also the bubbling of oxygen into the glass melt was found to be advantageous to avoid by oxidizing melting conditions a reduction of the bismuth to elemental bismuth.

TABLE 1

| | VG-1 | 1 | 2 | VG-2 |
|---|---|---|---|---|
| | mol-% | mol-% | mol-% | mol-% |
| SiO₂ | | 4.5 | | |
| GeO₂ | rest | rest | rest | rest |
| B₂O₃ | | | 4.5 | |
| Bi₂O₃ | 32.5 | 31.1 | 31.1 | 28.9 |
| Er₂O₃ | 0.06 | 0.06 | 0.06 | 0.06 |
| BaO | 4.3 | 4.1 | 4.1 | 9 |
| Na₂O | | | | |
| Li₂O | 4.8 | 4.6 | 4.6 | 8 |
| La₂O₃ | | | | 5 |
| ZnO | 9.7 | 9.3 | 9.3 | 9 |

TABLE 2

| | VG-1 | 1 | 2 | VG-2 |
|---|---|---|---|---|
| T_{g} [° C.] | 432 | 433 | 421 | 438 |
| Tₓ [° C.] | 516, 587, | 776 | 804 | 545 |
| | 661 | | | |
| T_{g} − Tₓ[° C.] | 79 | 94 | 102 | 107 |
| SP [° C.] | | | | |
| Tₘ [° C.] | 772, 840, | 776, 859, 907 | 804, 914 | 699, 789, 834 |
| | 896 | | | |
| κ [g/cm⁻³] | 6.9632 | 6.8323 | 6.8035 | 6.8413 |
| n (1300 nm) | 2.0599 | 2.0382 | 2.0362 | 2.046 |
| H₂O [mol/l] | | | | |
| H₂O [cm-1] | 0.701 | 0.704 | 0.428 | 1.133 |

TABLE 3

| | 2 | 3 | 4 | 5 |
|---|---|---|---|---|
| mol-% | mol-% | mol-% | mol-% | |
| GeO₂ | rest | rest | rest | rest |
| B₂O₃ | 4.5 | 4.5 | 4.5 | 4.5 |
| Bi₂O₃ | 31.1 | 28 | 25 | 28 |
| Er₂O₃ | 0.06 | 0.05 | 0.05 | 0.06 |
| BaO | 4.1 | 4.2 | 5 | 4 |
| Li₂O | 4.6 | 5 | 4.5 | 4.6 |
| La₂O₃ | | 9.2 | | 5 |
| WO₃ | | 5 | | |
| Ga₂O₃ | | | 10 | |
| ZnO | 9.3 | 9.2 | 9.4 | 8.8 |

| | 6 | 7 |
|---|---|---|
| | mol-% | mol-% |
| GeO₂ | rest | rest |
| B₂O₃ | 4.5 | 4.4 |
| Bi₂O₃ | 28 | 25 |
| Er₂O₃ | 0.06 | 0.06 |
| Al₂O₃ | | 2 |
| BaO | 4 | 4 |
| Na₂O | | |
| Li₂O | 4.7 | |
| Ga₂O₃ | | 10 |
| Gd₂O₃ | 4 | 5 |
| ZnO | 9.7 | 9.5 |

TABLE 4

| | 2 | 3 | 4 | 5 | 6 |
|---|---|---|---|---|---|
| T_{g} [° C.] | 421 | 434 | 448 | 445 | 444 |
| Tₓ [° C.] | 804 | 540 | 584 | 553 | 554 |
| T_{g} − Tₓ[° C.] | 102 | 106 | 136 | 109 | 110 |
| SP [° C.] | | | 518 | | |
| Tₘ [° C.] | 804, 914 | 671 | 857 | 795, 851, 873 | 792, 888, 921 |
| κ [g/cm⁻³] | 6.8035 | 6.7745 | 6.3787 | 6.7033 | 6.796 |
| n (1300 nm) | 2.0362 | 2.0309 | | 2.0217 | |
| H₂O [mol/1] | | | | | |
| H₂O [cm−1] | 0.428 | 0.514 | 0.633 | 0.503 | |
| α₂₀₋₃₀₀ [10⁻⁶/K] | | | 9.12 | 9.91 | 9.76 |
| τ [ms] | 3.33 | 3.09 | 2.9 | 3.13 | 3.17 |
| Y [GPa] | | | 81 +− 7 | | |
| CIL [N] | | | <0.3 | | |
| HV [GPa] | | | 5.2 +− 0.3 | | |
| B [μm^{-0.5}] | | | 11.9 +− 1.3 | | |
| K_{IC} | | | 0.44 +− 0.04 | | |
| [MPam^{0.5}] | | | | | |

Legend:
T_{g}: transformation temperature [° C.]
Tₓ: crystallization temperature [° C.]
SP: softening point [° C.]
Tₘ: melting point [° C.]
κ: density [g · cm⁻³]
n: refractive index
τ: life time of emission [ms]
Y: modulus of elasticity [GPa]
HV: Vicker's hardness [GPa]
B: bending strength [μm^{-0.5}]
K_{IC}: fracture toughness [MPam^{0.5}]
CIL: fracture initiating force [N]

TABLE 5

| | 8 | 9 | 10 |
|---|---|---|---|
| | mol-% | mol-% | mol-% |
| SiO₂ | | | |
| B₂O₃ | 4.5 | 4.5 | 4.5 |
| GeO₂ | rest | rest | rest |
| Bi₂O₃ | 28 | 28 | 29 |
| Er₂O₃ | 0.4 | | 0.06 |
| Eu₂O₃ | | 0.06 | |
| Na₂O | | | 5 |
| Li₂O | 4.6 | 4.6 | 4.6 |
| ZnO | 8.8 | 8.8 | 8.8 |
| BaO | 4 | 4 | 4 |
| La₂O₃ | 5 | 5 | |

TABLE 6

| | 8 | 9 | 10 |
|---|---|---|---|
| T_{g} [° C.] | 452 | 433 | 403 |
| Tₓ [° C.] | 625 | | 513 |
| T_{g} − Tₓ[° C.] | 173 | | 110 |
| SP [° C.] | | | |
| Tₘ [° C.] | 832, 880 | | 641, 759, 809 |
| κ [g/cm⁻³] | 6.7331 | 6.1745 | 6.5456 |
| n (1300 nm) | 2.0254 | | 2.0038 |
| H₂O [mol/l] | 0.005 | | |
| H₂O [cm-1] | 0.294 | | 0.391 |
| α₂₀₋₃₀₀ [10⁻⁶/K] | 9.94 | 9.98 | — |
| τ [ms] | 2.23 | | 2.83 |

TABLE 7

| | 11 | | | | | | |
|---|---|---|---|---|---|---|---|
| | mol- | 12 | 13 | 14 | 15 | 16 | 17 |
| | % | mol-% | mol-% | mol-% | mol-% | mol-% | mol-% |
| B₂O₃ | 4.5 | 4.5 | 4.4 | 4.5 | 4.5 | 4.4 | 4.4 |
| GeO₂ | rest | rest | rest | rest | rest | rest | rest |
| Bi₂O₃ | 25 | 26 | 28 | 25 | 25 | 28 | 28 |
| Er₂O₃ | 0.05 | 0.06 | 0.06 | 0.4 | | 0.4 | 0.06 |
| Eu₂O₃ | | | | | 0.06 | | |
| CeO₂ | | | 0.5 | | | 0.5 | 0.5 |
| Li₂O | 4.5 | 4.4 | 0.5 | 4.5 | 4.5 | 0.5 | 0.5 |
| ZnO | 9.5 | 9 | 10 | 9.5 | 9.5 | 10 | 10 |
| BaO | | 4 | 5 | 5 | 5 | 5 | |
| La₂O₃ | | 5 | | | | | 5 |
| Ga₂O₃ | 10 | 5 | 10 | 10 | 10 | 10 | 10 |
| WO₃ | 5 | | | | | | |

TABLE 8

| | 11 | 12 | 13 | 14 | 15 | 16 | 17 |
|---|---|---|---|---|---|---|---|
| T_{g} [° C.] | 452 | 469 | 459 | 451 | 468 | 444 | 487 |
| Tₓ [° C.] | 588 | 588, 692 | 593 | 590 | 595 | | 624 |
| T_{g} − Tₓ[° C.] | 136 | 136 | 134 | 139 | 127 | | 141 |
| SP [° C.] | | | 533 | | | | |
| Tₘ [° C.] | 810 | 810 | 875 | 852 | 871 | | 877, 920 |
| κ [g/cm⁻³] | 6.5508 | 6.3181 | 6.6398 | 6.4145 | 6.658 | 6.3817 | 6.7338 |
| n (1300 nm) | | | 2.0112 | 1.9723 | 2.0034 | | 2.018 |
| H₂O [mol/1] | | | 0.0054 | 0.005 | 0.0051 | 0.007 | 0.0071 |
| H₂O [cm−1] | | | 0.433 | 0.415 | 0.379 | | 0.416 |
| α₂₀₋₃₀₀[10⁻⁶/K] | 8.85 | 8.99 | 8.87 | | | 9.14 | 8.55 |
| τ [ms] | | 3.14 | 3.26 | 2.32 | 2.26 | | 2.8 |
| Y [GPa] | 73 +− 11 | | 85 +− 7 | | | | |
| CIL [N] | <0.3 | | <0.3 | | | | |
| HV[GPa] | 5.6 +− 0.3 | | 5.0 +− 0.2 | | | | |
| B [μm^{-0.5}] | 14.1 +− 1.0 | | 11.2 +− 1.4 | | | | |
| K_{IC} [MPam^{0.5}] | 0.40 +− 0.01 | | 0.45 +− 0.05 | | | | |

TABLE 9

| | 12 | 18 | 19 | 20 | 21 |
|---|---|---|---|---|---|
| | mol-% | mol-% | mol-% | mol-% | mol-% |
| SiO₂ | | | | | |
| B₂O₃ | 4.5 | 4.5 | 4.4 | 4.4 | 4.4 |
| GeO₂ | rest | rest | rest | rest | rest |
| Bi₂O₃ | 26 | 25 | 25.9 | 27 | 25.9 |
| Er₂O₃ | 0.06 | 0.06 | 0.06 | 0.06 | |
| Eu₂O₃ | | | | | 0.06 |
| CeO₂ | | | | 0.5 | |
| Na₂O | | | | | |
| Li₂O | 4.4 | 4 | 8.6 | 3 | 8.6 |
| ZnO | 9 | 7 | 7 | 7 | 7 |
| BaO | 4 | 3.9 | 5 | 6 | 5 |
| La₂O₃ | 5 | 5 | 5 | 5 | 5 |
| Al₂O₃ | | 5 | | | |
| Ga₂O₃ | 5 | 5.5 | 9 | 10 | 9 |
| | 22 | 23 | 24 | 25 | 26 |
| | mol-% | mol-% | mol-% | mol-% | mol-% |
| SiO₂ | | | | | |
| B₂O₃ | 4.4 | 4.5 | 4.5 | 4.4 | 4.4 |
| GeO₂ | rest | rest | rest | rest | rest |
| Bi₂O₃ | 26 | 26 | 31 | 28 | 25 |
| Er₂O₃ | 0.06 | 0.06 | 0.06 | 0.06 | 1.4 |
| CeO₂ | | 0.5 | | | |
| Na₂O | 5 | | 10 | 10 | 10 |
| Li₂O | 5 | 2 | | | |
| ZnO | 6 | 8 | 6 | 5 | 6 |
| BaO | 5 | 4 | 4 | 4 | 5 |
| La₂O₃ | 5 | 3.5 | 4 | 5 | 3.8 |
| Ga₂O₃ | 9 | 10 | 9 | 8.5 | 9 |

TABLE 10

| | 18 | 19 | 20 | 21 |
|---|---|---|---|---|
| T_{g} [° C.] | 453 | 441 | 468 | 437 |
| Tₓ [° C.] | (544), 586, | 578, 692 | 579 | |
| | 691 | | | |
| T_{g} − Tₓ[° C.] | (91), 133 | 137 | 111 | |
| SP [° C.] | | | 545 | |
| Tₘ [° C.] | 810 | 811, 858 | 847 | |
| κ [g/cm⁻³] | 6.5524 | 6.4698 | 6.6057 | 6.4762 |
| n (1300 nm) | 1.9973 | | 1.9997 | |
| H₂O [mol/l] | | 0.0063 | 0.0058 | 0.007 |
| H₂O [cm-1] | 0.612 | | 0.519 | |
| α₂₀₋₃₀₀ [10⁻⁶/K] | 9.48 | | 9.36 | 9.97 |
| τ [ms] | 3.14 | 3.12 | 3.29 | |
| Y [GPa] | 79 +− 13 | 90 +− 4 | 93 +− 8 | |
| CIL [N] | <0.3 | <0.3 | <0.3 | |
| HV [GPa] | 5.5 +− 0.1 | 5.1 +− 0.4 | 4.8 +− 0.2 | |
| B [μm^{-0.5}] | 13.4 +− 0.6 | 12.6 +− 1.5 | 11.3 +− 0.7 | |
| K_{IC} [MPam^{0.5}] | 0.41 +− 0.02 | 0.41 +− 0.02 | 0.43 +− 0.02 | |
| | 22 | 23 | 24 | 25 |
| T_{g} [° C.] | 433 | 475 | 425 | |
| Tₓ [° C.] | 571 | 608 | | |
| T_{g} − Tₓ[° C.] | 138 | 133 | | |
| Tₘ [° C.] | 746, 778, | 816, 862 | | |
| | 871 | | | |
| κ [g/cm⁻³] | 6.3373 | 6.5589 | 6.3862 | 6.2713 |
| n (1300 nm) | 1.9689 | 1.9931 | 1.9748 | |
| H₂O [mol/l] | | 0.0069 | | |
| H₂O [cm-1] | 0.725 | 0.563 | 0.637 | |
| α₂₀₋₃₀₀ [10⁻⁶/K] | 10.55 | 8.86 | 11.04 | |
| τ [ms] | 2.8 | 2.82 | 2.84 | 1.88 |

TABLE 11

| | 26 | 27 | 28 | 29 | 30 | 31 |
|---|---|---|---|---|---|---|
| | mol-% | mol-% | mol-% | mol-% | mol-% | mol-% |
| B₂O₃ | 3 | | 4.4 | 4.4 | 4.4 | 4.4 |
| GeO₂ | rest | rest | rest | rest | rest | rest |
| Bi₂O₃ | 30 | 28 | 27 | 27 | 27 | 28 |
| Er₂O₃ | 0.06 | 0.06 | 0.06 | 0.06 | 0.4 | 0.06 |
| CeO₂ | 0.5 | 0.5 | 0.5 | 0.5 | 0.5 | 0.5 |
| Li₂O | 3 | 2 | 3 | 3 | 3 | 3 |
| ZnO | 9 | 9.4 | 7 | 7 | 7 | 7 |
| BaO | 6 | 5 | 6 | 6 | 6 | 6 |
| La₂O₃ | | 4 | 5 | 5 | 5 | |
| Al₂O₃ | 3 | | | | | |
| Ga₂O₃ | 4 | 7 | 10 | 10 | 10 | 11 |
| Ta₂O₅ | | | | | | 4 |

TABLE 12

| | | | |
|---|---|---|---|
| 28 | 31 | 29 | 30 |

| | | | | |
|---|---|---|---|---|
| T_{g} [° C.] | 470 | | 457 | 466 |
| Tₓ [° C.] | 607 | | 603 | 606 |
| T_{g} − Tₓ[° C.] | 137 | 151 | 146 | 140 |
| SP [° C.] | | | | |
| Tₘ [° C.] | 828 | 831 | 842 | 848 |
| κ [g/cm⁻³] | | 6.7271 | | 6.6131 |
| n (1300 nm) | | 2.014 | 2.0015 | 1.9998 |
| H₂O [mol/l] | | | | 0.0043 |
| H₂O [cm-1] | | 0.462 | 0.471 | 0.347 |
| α₂₀₋₃₀₀ [10⁻⁶/K] | | | 9.33 | 9.3 |
| τ [ms] | 3.77 | 2.79 | 2.83 | 2.18 |

TABLE 13

| | 32 | 33 | 34 | 35 | 36 | 37 |
|---|---|---|---|---|---|---|
| | mol-% | mol-% | mol-% | mol-% | mol-% | mol-% |
| B₂O₃ | 4.8 | 4.5 | 4.8 | 4.8 | 4.5 | 4.8 |
| GeO₂ | rest | rest | rest | rest | rest | rest |
| Bi₂O₃ | 28 | 29 | 29 | 31.8 | 29 | 29 |
| Er₂O₃ | 0.06 | 0.06 | 0.06 | 0.06 | 1.8 | 0.06 |
| Na₂O | 17 | 17 | 17 | 17 | 17 | 20 |
| ZnO | | 4 | 2.1 | 2.3 | 4 | 2.1 |
| La₂O₃ | 3 | 3 | | 3 | 1.3 | |
| Ga₂O₃ | 15 | 10 | 15 | 12 | 10 | 15 |
| κ [g/cm⁻³] | | 6.1738 | 6.042 | 6.2673 | 6.2138 | 5.9816 |
| τ [ms] | 2.82 | 2.87 | 2.85 | 2.68 | 1.35 | 2.87 |

1. A bismuth oxide glass, comprising the following components (in mol-%, based on oxide content):
at least one component selected from the group formed by B₂O₃ and SiO₂≧0.1, but <5

| | |
|---|---|
| Bi₂O₃ | 20-45 |
| GeO₂ | 20-45 |
| rare earths | 0.001-15 |
| M′₂O | 0-30 |
| M″O | 0-20 |
| La₂O₃ | 0-15 |
| Ga₂O₃ | 0-40 |
| Gd₂O₃ | 0-10 |
| Al₂O₃ | 0-20 |
| CeO₂ | 0-10 |
| ZnO | 0-30 |
| other oxides rest, | |

wherein M′ is at least one component selected from the group formed by Li, Na, K, Rb and Cs, and wherein M″ is at least one component selected from the group formed by of Be, Mg, Ca, Sr and Ba.

2. A bismuth oxide glass, comprising the following components (in mol-%, based on oxide content):
at least one component selected from the group formed by B₂O₃ and SiO₂≧0.1, but <5

| | |
|---|---|
| Bi₂O₃ | 10-60 |
| GeO₂ | 10-60 |
| rare earths | 0-15 |
| M′₂O | 0-30 |
| M″O | 0-20 |
| La₂O₃ | 0-15 |
| Ga₂O₃ | 0-40 |
| Gd₂O₃ | 0-10 |
| Al₂O₃ | 0-20 |
| CeO₂ | 0-10 |
| ZnO | 0-30 |
| at least one component selected from the group | ≧1 |
| formed by B₂O₃ and SiO₂ | |
| other oxides | rest, |

wherein M′ is at least one component selected from the group formed by Li, Na, K, Rb and Cs, and wherein M″ is at least one component selected from the group formed by of Be, Mg, Ca, Sr and Ba.

3. The bismuth oxide glass of claim 2, wherein the glass comprises 0.005 to 15 mol-% (based on oxide content) of a rare earth.

4. The bismuth oxide glass of claim 2, wherein the glass comprises at least 0.01 to 8 mol-% of a rare earth selected from the group formed by Er₂O₃ and Eu₂O₃.

5. The bismuth oxide glass of claim 2, wherein the glass comprises at least 1 mol-% of at least one component selected from the group formed by B₂O₃ and SiO₂.

6. The bismuth oxide glass of claim 2, wherein the glass comprises at least 0.1 mol-%, of La₂O₃ but no more than 8 mol-% of La₂O₃.

7. The bismuth oxide glass of claim 1, wherein the glass comprises at least 1 mol-% of a component selected from the group formed by ZnO and BaO.

8. The bismuth oxide glass of claim 2, wherein the glass comprises at least 1 mol-% of a component selected from the group formed by ZnO and BaO.

9. The bismuth oxide glass of claim 8, wherein the glass comprises 1 to 15 mol-% of ZnO.

10. The bismuth oxide glass of claim 8, wherein the glass comprises 1 to 8 mol-% of BaO.

11. The bismuth oxide glass of claim 1, wherein the glass comprises 15 to 50 mol-% of GeO₂.

12. The bismuth oxide glass of claim 2, wherein the glass comprises 15 to 50 mol-% of Bi₂O₃.

13. The bismuth oxide glass of claim 2, wherein the glass comprises 0.1 to 30 mol-% of at least one component selected from the group formed by Na₂O and Li₂O.

14. The bismuth oxide glass of claim 2, wherein the glass comprises 0.5 to 15 mol-% of at least one component selected from the group formed by Na₂O and Li₂O.

15. The bismuth oxide glass of claim 2, wherein the glass comprises 1 to 20 mol-% of Ga₂O₃.

16. The bismuth oxide glass of claim 2, wherein the glass comprises 3 to 15 mol-% of Ga₂O₃.

17. The bismuth oxide glass of claim 2, wherein the glass comprises 0.1 to 2.0 mol-% of cerium oxide.

18. A process of producing an optically active glass comprising the following components (in mol-%, based on oxide content):

| | |
|---|---|
| B₂O₃ | ≧1 |
| Bi₂O₃ | 10-60 |
| GeO₂ | 10-60 |
| rare earths | 0-15 |
| M′₂O | 0-30 |
| M″O | 0-20 |
| La₂O₃ | 0-15 |
| Ga₂O₃ | 0-40 |
| Gd₂O₃ | 0-10 |
| Al₂O₃ | 0-20 |
| CeO₂ | 0-10 |
| ZnO | 0-30 |
| other oxides | rest, |

wherein M′ is at least one component selected from the group formed by Li, Na, K, Rb and Cs, wherein M″ is at least one component selected from the group formed by of Be, Mg, Ca, Sr and Ba, and
wherein ingredients for preparing the glass are mixed and molten in a crucible at a temperature of at least 1000° C. under oxidizing conditions.

19. The process of claim 18, wherein oxygen is bubbled into the melt.

20. The process of claim 18, wherein cerium oxide is added to the glass melt.
